(19) United States
(12) Patent Application Publication
(10) Pub. No.: US 2014/0059465 A1
(43) Pub. Date: Feb. 27, 2014

(54) MOBILE DEVICE WITH GRAPHICAL USER INTERFACE FOR INTERACTING WITH A BUILDING AUTOMATION SYSTEM

(71) Applicant: TRANE INTERNATIONAL INC., Piscataway, NJ (US)

(72) Inventors: Susan M. Mairs, St. Paul, MN (US); Bryan George Kinney, Stillwater, MN (US); Kimberly Hayman, Minneapolis, MN (US); Melissa Rose Schumann, Brooklyn Park, MN (US); Rachel Michael Nilsson, Minneapolis, MN (US); Jacob Larson, Minneapolis, MN (US)

(73) Assignee: TRANE INTERNATIONAL INC., Piscataway, NJ (US)

(21) Appl. No.: 13/972,276

(22) Filed: Aug. 21, 2013

Related U.S. Application Data
(60) Provisional application No. 61/691,552, filed on Aug. 21, 2012.

(51) Int. Cl. G06F 3/0484; G06F 3/0481

(52) U.S. Cl. CPC G06F 3/04842; G06F 3/04817
USPC 715/771

(57) ABSTRACT

A mobile device with a graphical user interface for remotely monitoring and/or remotely interacting with a configurable building automation systems (BAS). In particular, the mobile device's graphical user interface includes a screen portion and a navigation bar portion, wherein the navigation bar portion has plurality of icons, and each of the icons being associated with an interactive screen that can be displayed in the screen portion, one at a time.

### FIELD

This disclosure generally relates to a mobile device with a graphical user interface for remotely monitoring and/or operating a building automation system.

### BACKGROUND

A Building automation system (BAS) is used to coordinate, manage, and automate control of diverse environmental, physical, and electrical building subsystems, particularly HVAC and climate control, but also including security, lighting, power, and the like.

Hardwiring and programming of a BAS can create a robust fixed system customized for a particular installation. However, monitoring and maintenance of the BAS are still generally labor-intensive tasks that vary with each system implementation. In a common scenario, a user managing a building site must be at the location of the BAS and use a computer or other device hardwired to the BAS. If there is an issue with how the BAS is operating, the user managing the building site must physically be at the BAS to monitor the issue and to resolve the issue. If the user is not physically at the BAS location and receives notification that there is an issue with the BAS, generally, the user must physically go to the BAS location to monitor and to resolve the issue.

### SUMMARY

The embodiments described herein relate to a mobile device for interacting with a BAS remotely. Preferred embodiment relate to the mobile device for interacting with HVAC (heating, ventilation, and air conditioning) related aspects of the BAS.

The mobile device comprises a processor in communication with a memory, a network interface, and a touchscreen. The processor executes instructions for a graphical user interface (GUI) and displays the GUI on the touchscreen. The GUI includes a screen portion (or screen) and a navigation bar. The navigation bar includes a plurality of icons, each of the icons being associated with an interactive screen. When a user selects one of the icons of the navigation bar by touching the touchscreen, the selection is detected by the processor and the processor processes the associated one of the interactive screens to be displayed in the screen of the GUI. Accordingly, only one of the interactive screens is displayed at a time in the screen of the GUI.

The GUI is configured to receive operational instructions via the touchscreen, relay the operational instructions to the processor, the processor is configured to send the operational instructions to the BAS via a transmission from the network interface.

An interactive screen can include one or more icons. Each of these icons is associated with one of additional interactive screens. Each of the additional interactive screens is displayed in the screen of the GUI when an icon associated with the one of the additional interactive screens is selected by a touch of the touchscreen. That is, “additional interactive screens” describe “interactive screens” that can be accessed via icons displayed in one or more of the interactive screens. The terms interactive screens will be understood to include the additional interactive screens where appropriate. Accordingly, a description for the interactive screen can also describe the additional interactive screen as well.

In various embodiments, a quantity of icons can be one, two, three, four, five, six, seven, eight, nine, ten, or more. In various embodiments, a quantity of interactive screens can be one, two, three, four, five, six, seven, eight, nine, ten, or more.

When the user selects one of the icons by touching the touchscreen, from the navigation bar or from one of the interactive screens, the selection is detected by the processor and the processor processes the associated one of the interactive screens (including one of the additional interactive screens) to be displayed in the screen of the GUI, replacing the interactive screen (such as one of the interactive screens associated with one of the icons in the navigation bar, or one of the interactive screens that displays the icons) that was previously displayed in the screen of the GUI.

One or more of the interactive screens allows the user to interact with the BAS connected via the mobile device. Interaction includes, but is not limited to, monitoring, operating, controlling, and/or combinations thereof One or more of the interactive screens can be used to interact with the BAS, or a thing that is associated with the BAS, such as, but is not limited to, one or more of a component, a device, a unit, a system, a subsystem, a controller, a space, a building, a room, etc. The component may be the condenser or the evaporator, the unit may be a chiller, the system can be a HVAC system or circuit, the subsystem can be a control system for the HVAC system.

For example, the interactive screens includes one or more of status data of the BAS in real time, status history data of the BAS, an alarm data of the BAS in real time, an alarm history data of the BAS, an interactive control for setting an operational condition of the BAS, an interactive control for changing a first operational condition with a second operational condition of the BAS, an interactive blueprint of a building and real time status data of one or more areas of the building that is operationally connected to the BAS, and/or an operation schedule data of the BAS in real time.

The embodiments described provide the user with a mobile device with a GUI having a plurality of interactive screens for monitoring and/or interacting with the BAS, wherein each of the interactive screens are one or two “clicks” (touches of the touchscreen) away from each other. This mechanism provides the user with a specialized mobile device that is very simple to use, yet very robust.

### BRIEF DESCRIPTION OF THE DRAWINGS

Referring now to the drawings in which like reference numbers represent corresponding parts throughout.

FIG. 1 is a cartoon diagram of a building automation system (BAS) connected to a mobile device according to one embodiment.

FIG. 2 is a schematic diagram of a mobile device according to one embodiment.

FIGS. 3-6 are schematic diagrams of a graphical user interface (GUI) of a mobile device according to an embodiment.

FIG. 7 is an example portion of a graphic user interface diagram according to an embodiment.

FIG. 8 is an example of a mobile device according to an embodiment.

FIGS. 9-11 are examples of a mobile device according to an embodiment.

FIG. 12 is an example of a mobile device according to an embodiment.

FIG. 13 is an example portion of a graphic user interface diagram according to an embodiment.

### DETAILED DESCRIPTION

The embodiments described herein are directed to a mobile device with a graphical user interface for remotely monitoring and/or operating a building automation system.

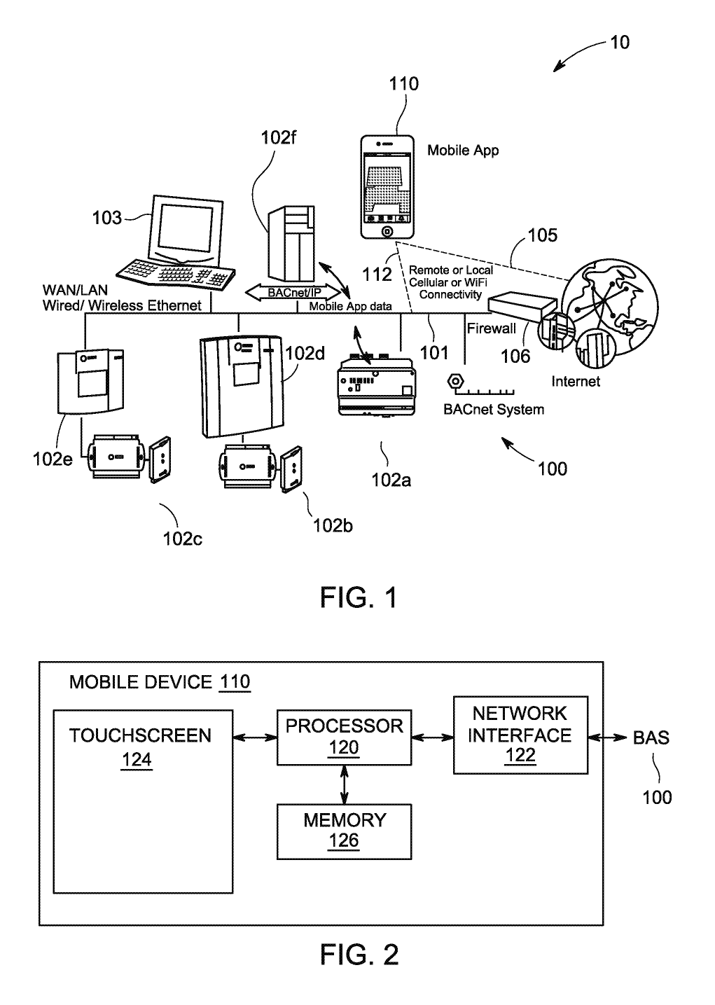

FIG. 1 shows a cartoon of a system 10 including an embodiment of a BAS 100 that includes a hardwired network 101 that uses a communication standard or protocol to link various subsystems, such as a system control unit 102a, a unit control device 102b, 102c, and/or other devices 102d, 102e, 102f, and provide a system-wide user access and control from a computer 103 hardwired to the network. The BAS 100 is connected to the internet 105, and includes a network security device 106, such as a firewall, that secures and protects the BAS 100 from unwanted intrusion via the internet 105.

The embodiment includes a mobile device 110 connectable to the BAS 100 via the internet 105, accessing the BAS 100 through the network security device 106. The mobile device 110 can connect to the BAS 100 via a local wireless connection 112. The local wireless connection 112 can be established behind the network security device 106, so that the mobile device 110 can connect to one or more of the components or devices 102a-f of the BAS 100 without requiring the communication between the mobile device 110 and the BAS 100 to go through the network security device 106.

The mobile device 110 can connect to the BAS 100 via the internet 105 using cellular, 3G, 4G, or other wireless communication protocol. The mobile device 110 can connect to the BAS 100 via the local wireless connection 112 using WiFi, bluetooth, or other wireless communication protocol. The mobile device 110 can connect to the BAS 100 using a combination of the internet 105 and local wireless connection 112.

FIG. 2 shows an illustrated schematic diagram of an embodiment of a mobile device 110. The mobile device 110 includes a processor 120 in communication with a network interface 122 and a touchscreen 124. The touchscreen 124 is a combination display and a human-computer interface device. The touchscreen 124 displays images as instructed by the processor 120. The touchscreen 124 can detect user input via touch or contact by a human finger or a stylus device, and sends the input to the processor 120. A memory 126 is in communication with the processor 120, and the memory 126 stores instructions for an operating system that is executed by the processor 120. The memory 126 can also store instructions for a computer program that is executed by the processor 120. The computer program includes a graphical user interface (GUI) for remote operation of a BAS 100.

Embodiments of the mobile device 110 include, but are not limited to, a smartphone, an iPhone, an iPad, an iPod, an Android phone, an Android tablet, a Windows phone, a Windows tablet, etc. Embodiments of the operating system include, but are not limited to, iOS, Android OS (e.g. Donut, Eclair, Gingerbread, Honeycomb, Ice Cream Sandwich, Jelly Bean, etc.), Windows, etc. Embodiments of the computer program include, but are not limited to, software for mobile device 110s commonly called an “App” or “Mobile App,” a script written in a scripting language, etc.

According to an embodiment, a graphical user interface (GUI) is displayed on the touchscreen 124 when the computer program instructions are executed by the processor 120, the GUI displays information to a user and also provides various input points for the user to interact with the GUI so that the user is allowed to provide input, such as operational commands or data request, which is sent to the processor 120. The processor 120 can then process the input according to the computer program instructions being executed and can communicate with the memory 126 and/or network interface 122 to provide data to be displayed on the touchscreen 124.

An embodiment of a computer program is stored on a computer readable medium, wherein the computer program includes computer readable instructions that can be executed by a processor 120 to display a GUI on a touchscreen 124 configured to provide data output on the touchscreen 124, and at the same time, receive operational input for remotely monitoring and/or operating a BAS 100. The data output provided can be in real time, as the data is received from the BAS 100 to the mobile device 110 via the network interface 122 of the mobile device 110.

Accordingly, a user of the mobile device 110 can be located almost anywhere and monitor and/or interact with the operation of the BAS 100, as long as the mobile device 110 can wirelessly connect to the BAS 100.

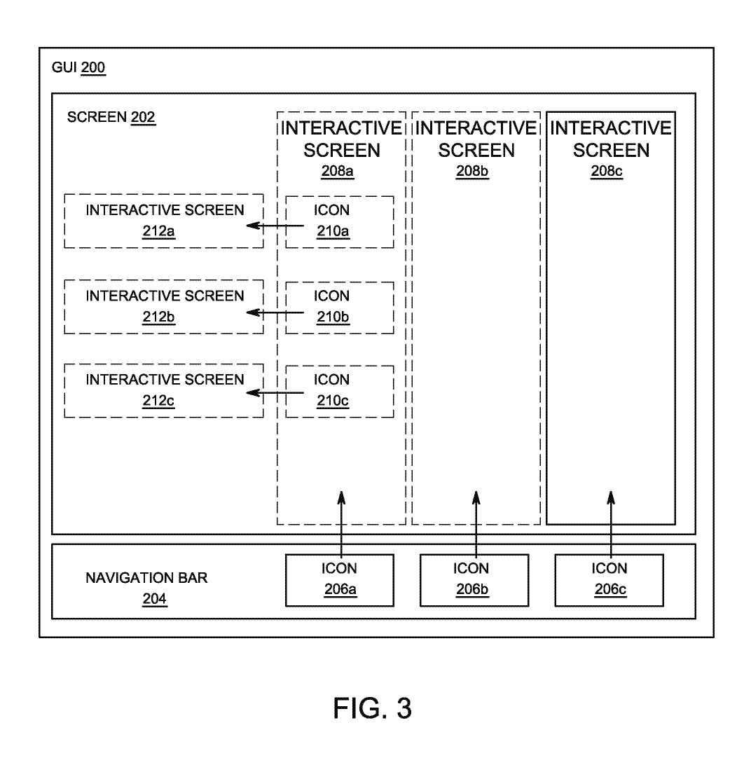

FIGS. 3-6 show schematic diagrams of an embodiment of a GUI 200 for a mobile device for remote operation and/or monitoring of a BAS. Various components of the GUI 200 that are not displayed in the screen 202 are illustrated with dotted lines.

The mobile device can be the embodiment shown in FIG. 2. Accordingly, the mobile device has a touchscreen displaying a GUI 200 which includes a screen portion 202 (or screen) and a navigation bar portion (or navigation bar) 204. In an embodiment, the navigation bar 204 can be displayed always in the GUI 200 when the GUI 200 shows the screen 202. It will be understood that the GUI 200 can include other components so that the GUI 200 displays other interactive components than the embodiment having the screen 202 and the navigation bar 204.

The screen 202 is a portion of the GUI 200 that can display images when a user interacts with the navigation bar 204 by touching the touchscreen of the mobile device.

The navigation bar 204 includes a plurality of icons 206a, 206b, 206c. It is to be understood that the term icon describes a computer generated graphic image that is used in the GUI 200 for displaying information and/or for allowing a human to interact with the mobile device. Each of the icons 206a-c is associated with one of interactive screens 208a, 208b, 208c respectively. When one of the icons 206a-c is selected by touching the touchscreen, the interactive screen 208a-c associated with the selected icon is displayed in the screen 202 of the GUI 200, as indicated in FIGS. 3-6 with arrows from each of the icons 206a-c to their respective interactive screens 208a-c. Instructions for the interactive screens 208a-c are stored in the memory of the mobile device and executed by the processor of the mobile device. When one of the interactive screens 208a-c is displayed in the screen 202, the other interactive screens are not displayed in the screen 202.

For example, FIG. 3 shows the icon 206c having been selected. Accordingly, the interactive screen 208c is displayed in the screen 202. The other interactive screens 208a-b, 212a, 212b, 212c (which, as indicated by the reference numbers, include the additional interactive screens 212a-c that are not directly accessible from the navigation bar 204) are not displayed in the screen 202, indicated by dotted lines in FIG. 3. Further, additional icons 210a, 210b, 210c of the interactive screen 208a are not displayed in the screen 202 because the additional icons 210a-c are shown only when the interactive screen 208a is displayed in the screen 202.

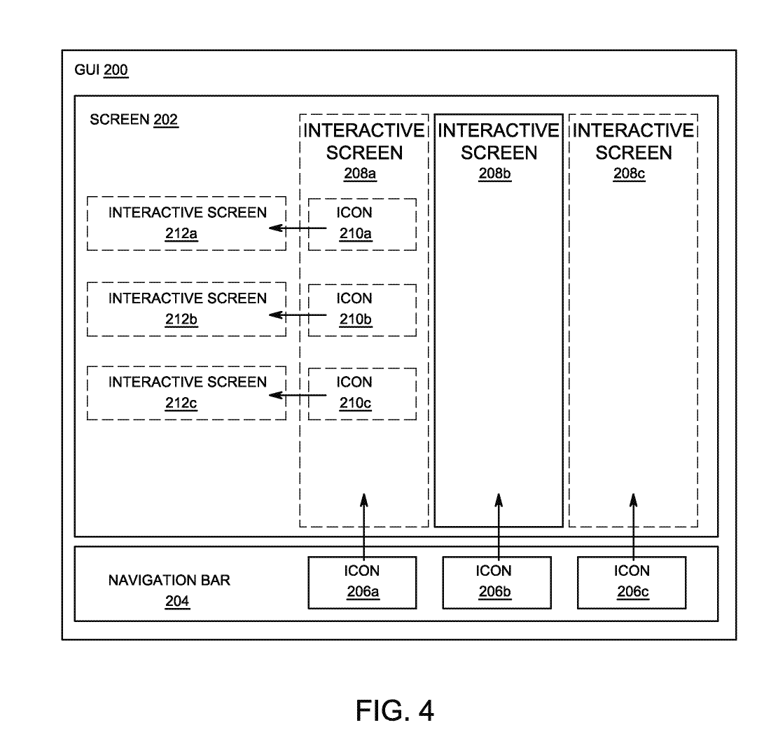

FIG. 4 shows the icon 206b having been selected. Accordingly, the interactive screen 208b is displayed in the screen 202. The other interactive screens 208a, 208c, 212a-c, are not displayed in the screen 202, indicated by dotted lines in FIG. 4. Accordingly, in FIG. 4, the additional icons 210a-c of the interactive screen 208a are not displayed in the screen 202 because the additional icons 210a-c are shown only when the interactive screen 208a is displayed in the screen 202. A transition from the interactive screen 208c being displayed in the screen 202 as shown in FIG. 3 to the interactive screen 208b being displayed in the screen 202 would require only one “click” (or touch of the touchscreen) of the icon 206b.

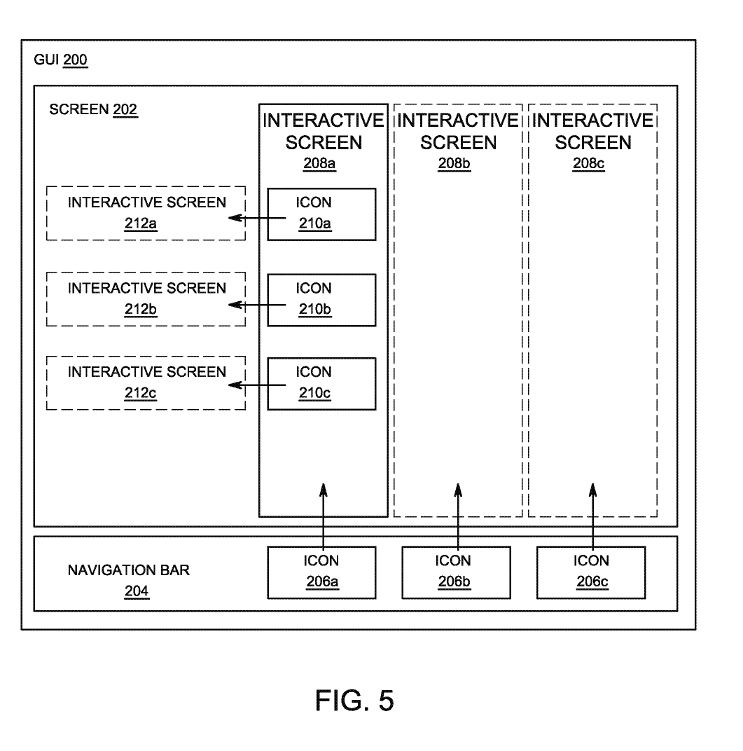

FIG. 5 shows the icon 206a having been selected. Accordingly, the interactive screen 208a is displayed in the screen 202. The other interactive screens 208b-c, 212a-c, are not displayed in the screen 202, indicated by dotted lines in FIG. 5. Accordingly, in FIG. 5, the additional icons 210a-c of the interactive screen 208a are displayed in the screen 202 because the additional icons 210a-c are shown when the interactive screen 208a is displayed in the screen 202. A transition from one of the interactive screens 208b-c being displayed in the screen 202 as shown in FIGS. 3-4 to the interactive screen 208a being displayed in the screen 202 would require only one “click” (or touch of the touchscreen) of the icon 206a.

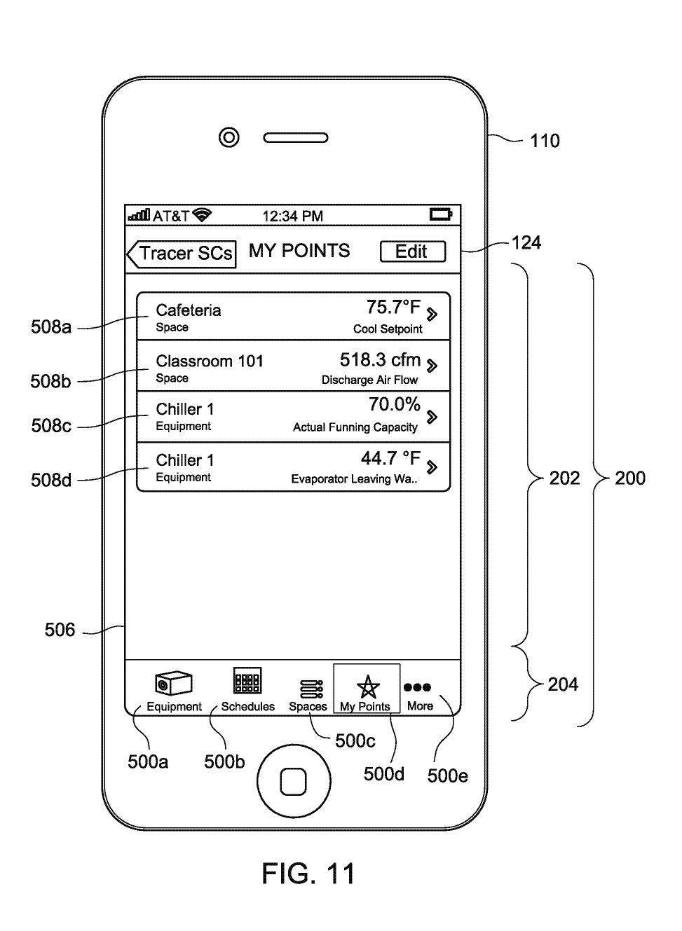

The interactive screen 208a and the additional icons 210a-c can be described as an extension of the navigation bar 204 and/or the icons 206a-c of the navigation bar 204. For example, the icon 206a may be labeled as “MORE,” providing a cue to a user that there are additional icons that can be accessed when the MORE icon is selected. The GUI 200 can include one or more interactive screens similar to the interactive screen 208a (see for example, FIG. 11).

Each of the additional icons 210a-c of the interactive screen 208a are associated with the interactive screens 212a-c, respectively. When one of the icons 210-c is selected by touching the touchscreen, the interactive screen 212a-c associated with the selected icon is displayed in the screen 202 of the GUI 200, as indicated in FIGS. 3-6 with arrows from each of the icons 210a-c to their respective interactive screens 212a-c.

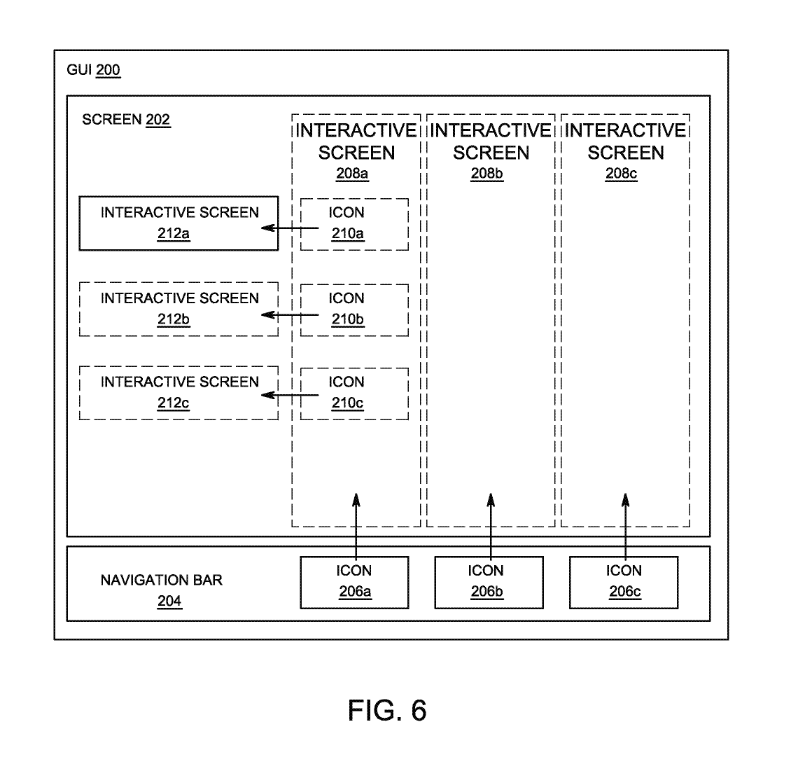

FIG. 6 shows what is displayed in the screen 202 when the icon 210a is selected. The processor detects the selection of the icon 210a, and the processor causes the interactive screen 208a to be not displayed in the screen 202 as indicated by dotted lines in FIG. 6, and then the interactive screen 212a is displayed in the screen 202. The other interactive screens 208a-c, 212b-c are also not displayed in the screen 202, indicated by dotted lines in FIG. 6.

The interactive screen 212a that is displayed in the screen 202 of the GUI 200 is not directly associated with any of the icons 206a-c provided in the navigation bar 204.

A transition from one of the interactive screens 208b-c being displayed in the screen 202 as shown in FIGS. 3-4 to the interactive screen 212a being displayed in the screen 202 would require only two “clicks” (or touch of the touchscreen), first “click” being the icon 206a, and then the second “click” being the icon 210a.

A transition from one of the additional interactive screens 212a-c to one of the interactive screens 208a-c would require only one “click” (or touch of the touchscreen) of one of the icons 206a-c.

Thus, the embodiment of the GUI 200 in FIGS. 3-6 provides a plurality of interactive screens 208a-c, 212a-c for monitoring and/or interacting with the BAS, wherein each of the interactive screens 208a-c, 212a-c are one or two “clicks” (touches of the touchscreen) away from each other. The GUI 200 provides the user with a specialized mobile device that is very simple and quick to use for monitoring and/or interacting with the BAS.

In various embodiments, the interactive screens can include status data of the BAS in real time, status history data of the BAS, an alarm data of the BAS in real time, an alarm history data of the BAS, an interactive control for setting an operational condition of the BAS, an interactive control for changing a first operational condition with a second operational condition of the BAS, an interactive blueprint of a building and real time status data of one or more areas of the building that is operationally connected to the BAS, an operation schedule data of the BAS in real time, and/or any combinations thereof.

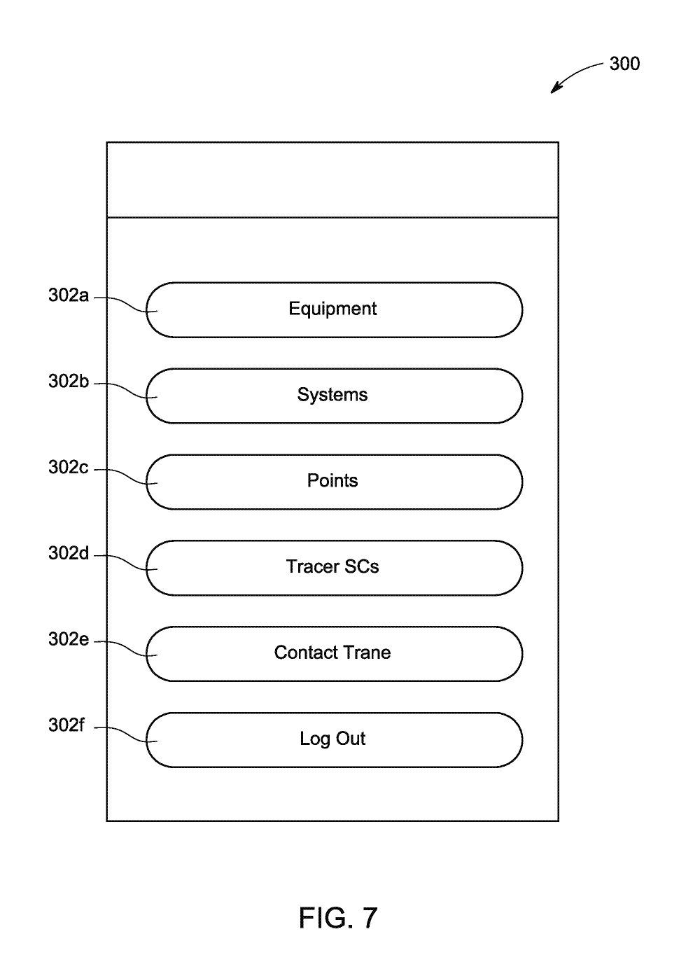

FIG. 7 shows an example interactive screen 300, similar to the interactive screen 208a in FIGS. 3-6. The interactive screen 300 includes a plurality of additional icons 302a, 302b, 302c, 302d, 302e, 302f The interactive screen 300 can be displayed in the screen of the GUI of the mobile device.

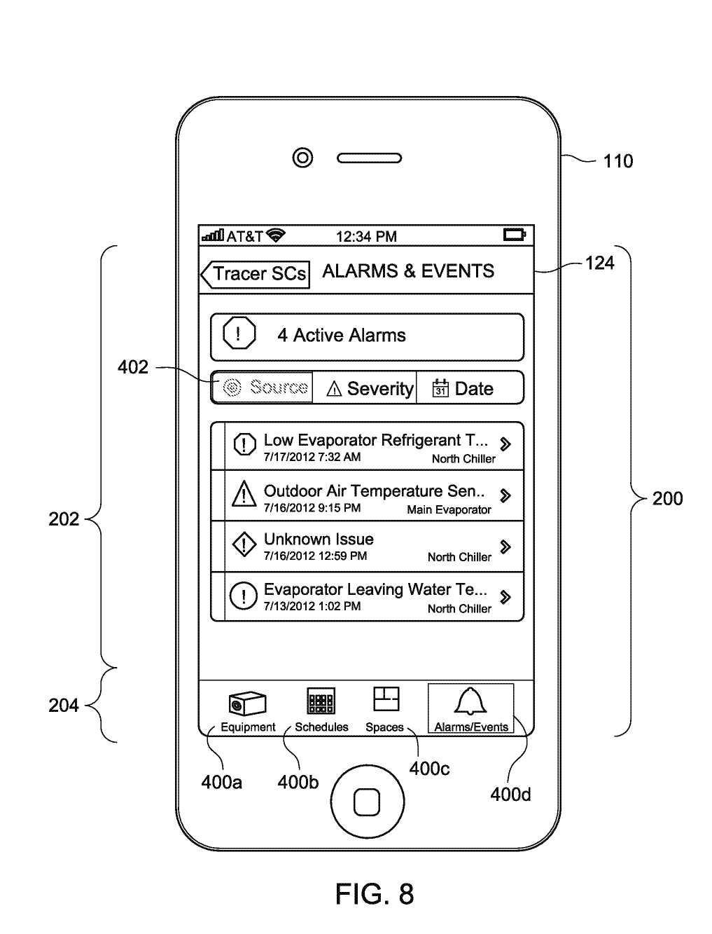

FIGS. 8-11 show various examples of the embodiment of the mobile device 110 having the GUI 200 displayed in the touchscreen 124, wherein the GUI 200 includes the screen 202 and the navigation bar 204.

FIG. 8 shows the navigation bar 204 having four icons 400a, 400b, 400c, 400d, wherein icon 400d has been selected and an interactive screen 402 that is associated with the selected icon 400d is displayed in the screen 202. The interactive screen 402 includes status data of the BAS in real time, status history data of the BAS, an alarm data of the BAS in real time, and an alarm history data of the BAS.

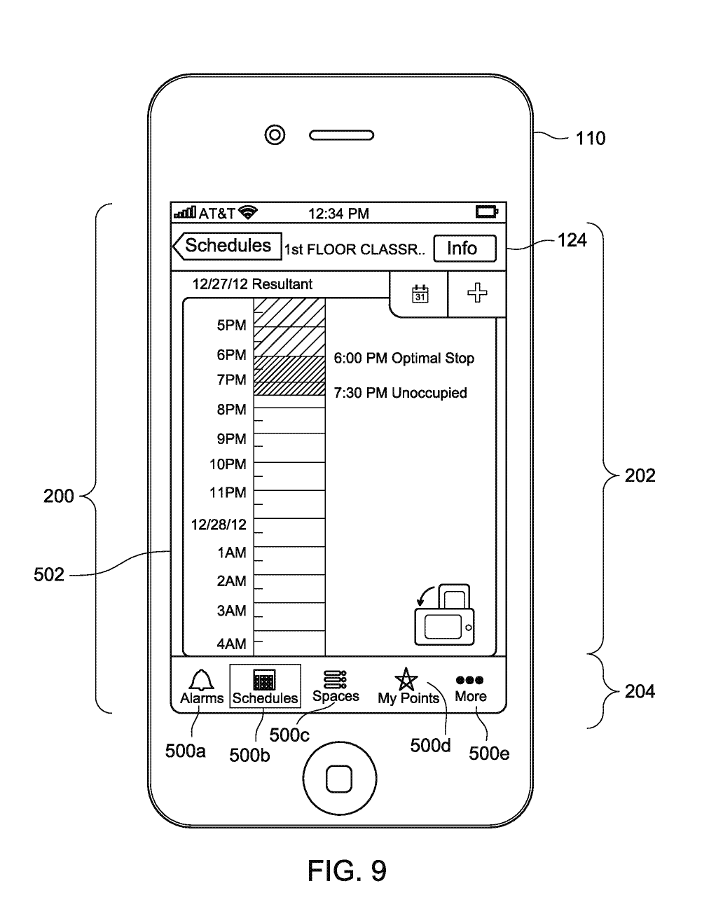

FIGS. 9-11 show the navigation bar 204 having five icons 500a, 500b, 500c, 500d, 500e.

FIG. 9 shows the icon 500b having been selected and an interactive screen 502 that is associated with the selected icon 500b displayed in the screen 202. The interactive screen 502 includes an operation schedule data of the BAS in real time, and an interactive control for setting an operational condition of the BAS, and an interactive control for changing a first operational condition with a second operational condition of the BAS.

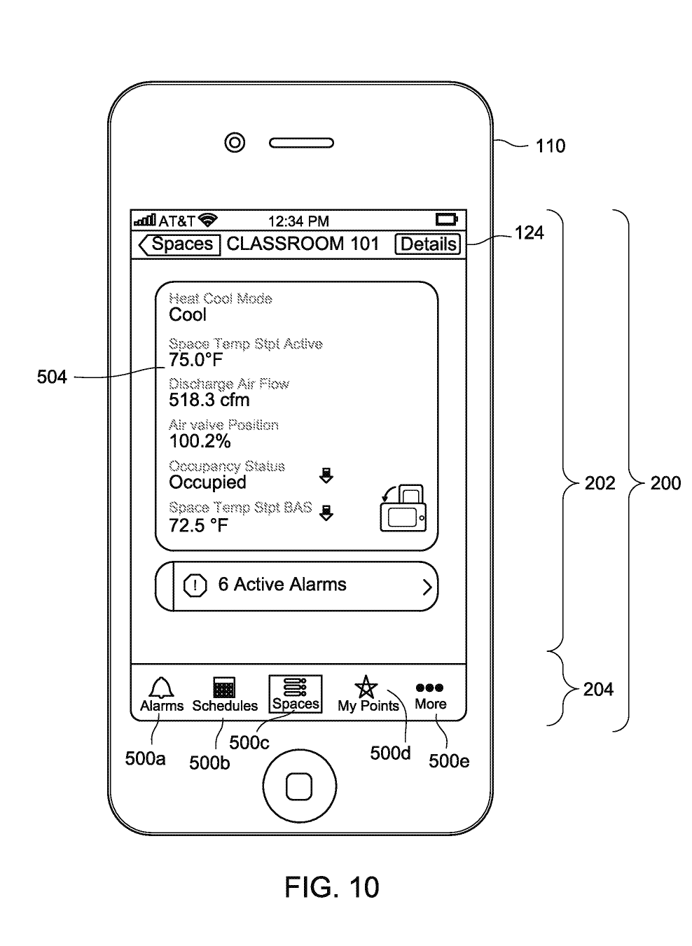

FIG. 10 shows the icon 500c having been selected and an interactive screen 504 that is associated with the selected icon 500c displayed in the screen 202. The interactive screen 504 includes status data of the BAS (i.e. Classroom 101 that is associated with the BAS) in real time, and an alarm data of the BAS in real time.

FIG. 11 shows the icon 500d having been selected and an interactive screen 506 that is associated with the selected icon 500d displayed in the screen 202. The interactive screen 506 includes status data of the BAS (as a list format of various rooms and devices associated with the BAS) in real time.

The interactive screen 506 is another example of an interactive screen having a plurality of additional icons 508a, 508b, 508c, 508d, wherein each of the additional icons 508a-c of the interactive screen 506 are associated with additional interactive screens (not shown), respectively. When one of the icons 508a-d is selected by touching the touchscreen, the interactive screen associated with the selected icon is displayed in the screen 202 of the GUI 200. The interactive screen 506 provides a user a touch-based interface for adding and/or removing the icons 508a, 508b, 508c, 508d from the interactive screen 506. Accordingly, any interactive screen that would normally require numerous “clicks” to access using the GUI 200 can be added to the interactive screen 506. This allows the GUI 200 to be configurable to a user's wants and needs for quick access to particular interactive screens. Thus, the configurability of the interactive screen 506 of the GUI 200 allows any interactive screen to be accessible within one or two “clicks.”

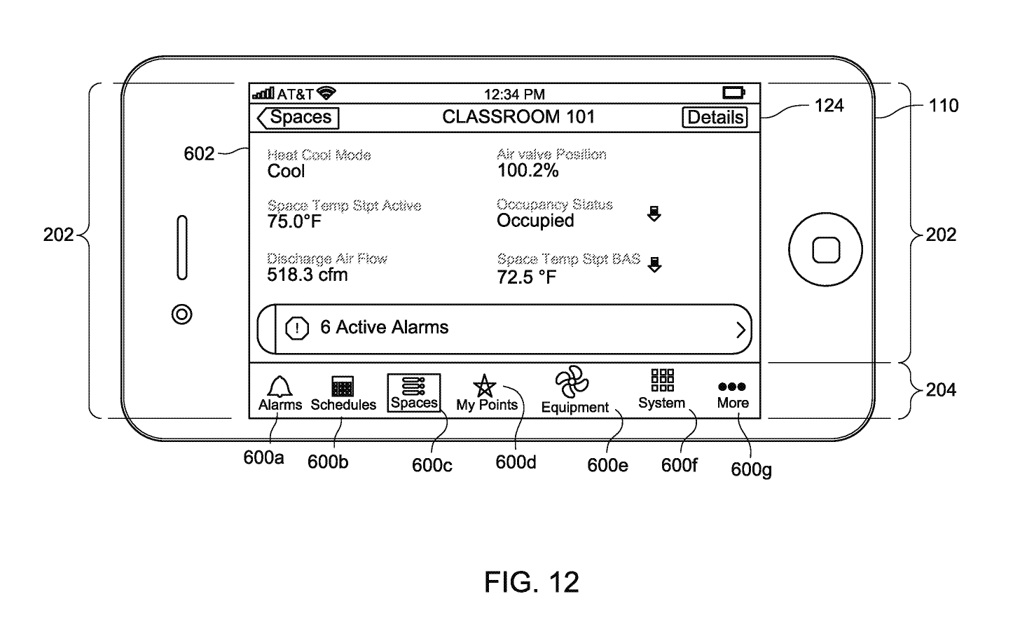

FIG. 12 shows another example of the embodiment of the mobile device 110 having the GUI 200 displayed in the touchscreen 124, wherein the GUI 200 includes the screen 202 and the navigation bar 204. The navigation bar 204 includes seven icons 600a, 600b, 600c, 600d, 600e, 600f, 600g. Icon 600c has been selected and an interactive screen 602 that is associated with the selected icon 600c is displayed in the screen 202. The interactive screen 602 includes status data of the BAS (i.e. Classroom 101 that is associated with the BAS) in real time, and an alarm data of the BAS in real time.

In FIGS. 9-12, one of the icons 500e, 600g is labeled “MORE,” providing a cue to a user that there are additional icons that can be accessed when the MORE icon is selected. The functionality of the MORE icon is similar to that of the icon 206a described above for FIGS. 3-6.

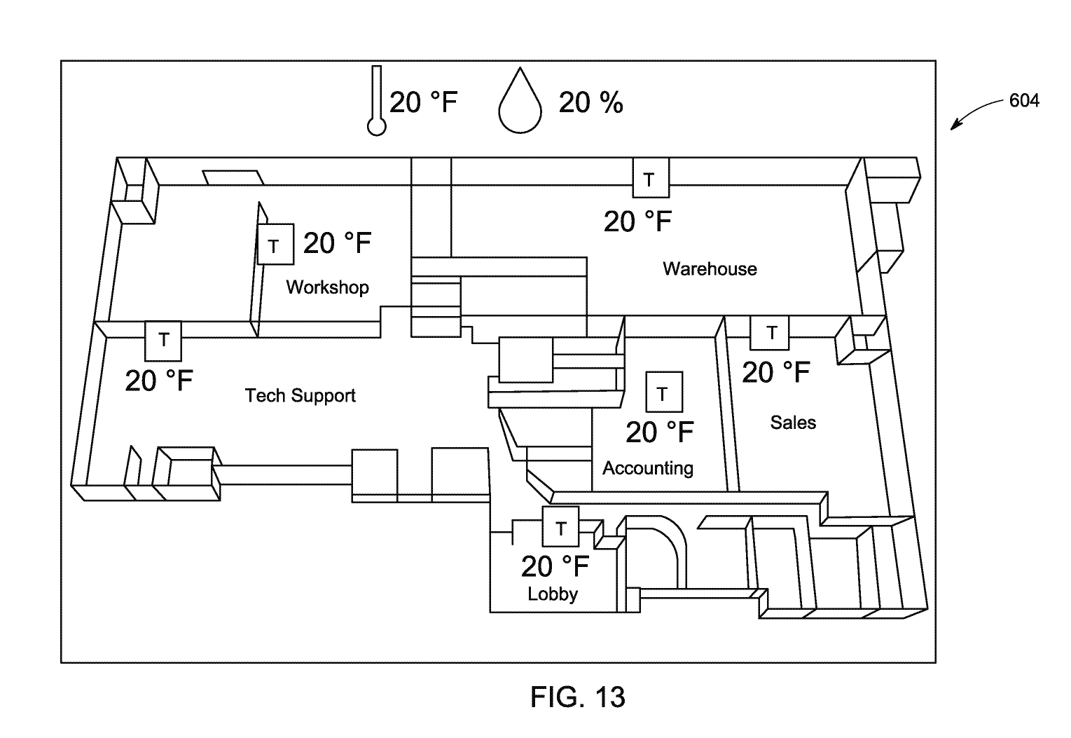

FIG. 13 shows an example of an interactive screen 604 including an interactive blueprint of a building and real time status data of one or more areas of the building that is operationally connected to the BAS. The interactive screen 604 can be displayed when an icon, such as, for example icon 500b or icon 600b is selected from examples in FIGS. 9-12.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

What is claimed is:

1. A mobile device for remote operation of a building automation system, comprising:
a processor in communication with a memory, a network interface, and a touchscreen;
the processor executing instructions for a graphical user interface and displaying the graphical user interface on the touchscreen,
the graphical user interface includes a screen and a navigation bar, the navigation bar includes a plurality of icons, each of the icons is associated with one of a plurality of interactive screens, wherein a selection of one of the icons by touching the touchscreen is detectable by the processor to display in the screen one of the interactive screens associated with the one of the icons selected, wherein only one of the interactive screens is displayed in the screen at a time.

2. The mobile device according to claim 1, wherein one of the interactive screens includes one or more additional icons, wherein each of the additional icons is associated with one of additional interactive screens,
a selection of one of the additional icons by touching the touchscreen is detectable by the processor to display in the screen one of the additional interactive screens associated with the one of the additional icons selected, in place of the one of the interactive screens that includes the one or more additional icons.

3. The mobile device according to claim 1, wherein the interactive screens includes one or more of status data of the building automation system in real time, status history data of the building automation system, an alarm data of the building automation system in real time, an alarm history data of the building automation system, an interactive control for setting an operational condition of the building automation system, an interactive control for changing a first operational condition with a second operational condition of the building automation system, an interactive blueprint of a building and real time status data of one or more areas of the building that is operationally connected to the building automation system, and/or an operation schedule data of the building automation system in real time.
